(19) United States
(12) Patent Application Publication
(10) Pub. No.: US 2026/0149815 A1
(43) Pub. Date: May 28, 2026

(54) VIDEO DATA COMMUNICATION WITH SELECTIVE TRANSMISSION OF FRAMES

(71) Applicant: Beijing Zitiao Network Technology Co., Ltd., Beijing (CN)

(72) Inventor: Haijun LIU, Beijing (CN)

(21) Appl. No.: 18/963,221

(22) Filed: Nov. 27, 2024

(51) Int. Cl. H04N 19/164; H04L 65/75; H04N 19/103; H04N 19/156; H04N 19/172

(52) U.S. Cl. CPC H04N 19/164; H04L 65/765; H04N 19/103; H04N 19/156; H04N 19/172

(57) ABSTRACT

Embodiments of the present disclosure provide a solution for video data communication with selective transmission of frames. A method comprises: obtaining, at a first apparatus, encoded data of a video comprising a set of frames, each of the set of frames being assigned to one of a plurality of levels based on a reference relationship of the set of frames; receiving, from a second apparatus, feedback information associated with at least one performance attribute representing performance information for processing the encoded data of the video at the second apparatus; selecting at least one target frame from the set of frames based on the feedback information and the plurality of levels; and transmitting encoded data of the at least one target frame to the second apparatus.

### FIELD

Example embodiments of the present disclosure generally relate to the field of communication, and more particularly, to video data communication with selective transmission of frames.

### BACKGROUND

In recent years, mobile terminals such as mobile phones and tablets have penetrated various areas of people's life. Video conference is becoming an increasingly popular way of online communication. For example, a user can hold a remote meeting through a video conference implemented with real-time communication (RTC). The RTC is a near-simultaneous exchange of information over any type of telecommunications service from a sender to a receiver in a connection with smaller end-to-end latency. However, the end-to-end latency in RTC is affected by various factors and thus it is generally expected to reduce the end-to-end latency adaptively.

### SUMMARY

In a first aspect of the present disclosure, a method for video data communication is provided. The method comprises: obtaining, at a first apparatus, encoded data of a video comprising a set of frames, each of the set of frames being assigned to one of a plurality of levels based on a reference relationship of the set of frames; receiving, from a second apparatus, feedback information associated with at least one performance attribute representing performance information for processing the encoded data of the video at the second apparatus; selecting at least one target frame from the set of frames based on the feedback information and the plurality of levels; and transmitting encoded data of the at least one target frame to the second apparatus.

In a second aspect of the present disclosure, another method for video data communication is provided. The method comprises: transmitting, at a second apparatus and to a first apparatus, feedback information associated with at least one performance attribute representing performance information for processing encoded data of a video at the second apparatus; and receiving, from the first apparatus, encoded data of the at least one target frame of the video, the at least one target frame being dependent on the feedback information.

In a third aspect of the present disclosure, an electronic device is provided. The electronic device comprises: at least one processing unit; and at least one memory coupled to the at least one processing unit and storing instructions for execution by the at least one processing unit that, when executed by the at least one processing unit, cause the electronic device to perform acts comprising: obtaining, at a first apparatus, encoded data of a video comprising a set of frames, each of the set of frames being assigned to one of a plurality of levels based on a reference relationship of the set of frames; receiving, from a second apparatus, feedback information associated with at least one performance attribute representing performance information for processing the encoded data of the video at the second apparatus; selecting at least one target frame from the set of frames based on the feedback information and the plurality of levels; and transmitting encoded data of the at least one target frame to the second apparatus.

In a fourth aspect of the present disclosure, another electronic device is provided. The electronic device comprises: at least one processing unit; and at least one memory coupled to the at least one processing unit and storing instructions for execution by the at least one processing unit that, when executed by the at least one processing unit, cause the electronic device to perform acts comprising: transmitting, at a second apparatus and to a first apparatus, feedback information associated with at least one performance attribute representing performance information for processing encoded data of a video at the second apparatus; and receiving, from the first apparatus, encoded data of the at least one target frame of the video, the at least one target frame being dependent on the feedback information.

In a fifth aspect of the present disclosure, a non-transitory computer readable storage medium is provided. The non-transitory computer readable storage medium has a computer program stored thereon, the computer program being executable by a processor to perform acts comprising: obtaining, at a first apparatus, encoded data of a video comprising a set of frames, each of the set of frames being assigned to one of a plurality of levels based on a reference relationship of the set of frames; receiving, from a second apparatus, feedback information associated with at least one performance attribute representing performance information for processing the encoded data of the video at the second apparatus; selecting at least one target frame from the set of frames based on the feedback information and the plurality of levels; and transmitting encoded data of the at least one target frame to the second apparatus.

In a fifth aspect of the present disclosure, another non-transitory computer readable storage medium is provided. The non-transitory computer readable storage medium has a computer program stored thereon, the computer program being executable by a processor to perform acts comprising: transmitting, at a second apparatus and to a first apparatus, feedback information associated with at least one performance attribute representing performance information for processing encoded data of a video at the second apparatus; and receiving, from the first apparatus, encoded data of the at least one target frame of the video, the at least one target frame being dependent on the feedback information.

It should be understood that the content described in this Summary section is not intended to limit the key features or important features of the embodiments of the disclosure, nor is it intended to limit the scope of the disclosure. Other features of the present disclosure will be readily envisaged through the following description.

### BRIEF DESCRIPTION OF THE DRAWINGS

The above and other features, advantages and aspects of the embodiments of the present disclosure will become more apparent in combination with the accompanying drawings and with reference to the following detailed description. In the drawings, the same or similar reference symbols refer to the same or similar elements, where:

FIG. 1 illustrates a schematic diagram of an example environment in which embodiments of the present disclosure can be implemented;

FIG. 2 illustrates a schematic diagram of an IPPPPPP structure;

FIG. 3 illustrates a signaling chart for video data communication according to some example embodiments of the present disclosure;

FIG. 4 illustrates a schematic diagram of an IBPBPBP structure in a presentation time stamp (PTS) order;

FIG. 5 illustrates a schematic diagram of the IBPBPBP structure in a decoding time stamp (DTS) order;

FIG. 6 illustrates a schematic diagram of a hierarchical structure of the IBPBPBP structure;

FIG. 7 illustrates a schematic diagram of an architecture for video data communication according to some example embodiments of the present disclosure;

FIG. 8 illustrates a schematic diagram of a group of pictures (GOP) structure after frame dropping according to some example embodiments of the present disclosure;

FIG. 9 illustrates a schematic diagram of another GOP structure after frame dropping according to some example embodiments of the present disclosure;

FIG. 10 illustrates a flowchart of a method for video data communication according to some example embodiments of the present disclosure;

FIG. 11 illustrates a flowchart of a method for video data communication according to some example embodiments of the present disclosure;

FIG. 12 illustrates a block diagram of a first apparatus for video data communication according to some example embodiments of the present disclosure;

FIG. 13 illustrates a block diagram of a second apparatus for video data communication according to some example embodiments of the present disclosure; and

FIG. 14 illustrates a block diagram of an electronic device in which one or more embodiments of the present disclosure can be implemented.

### DETAILED DESCRIPTION

The embodiments of the present disclosure will be described in more detail below with reference to the accompanying drawings. Although some example embodiments of the present disclosure are shown in the drawings, it would be appreciated that the present disclosure may be implemented in various forms and should not be interpreted as limited to the embodiments described herein. On the contrary, these embodiments are provided for a more thorough and complete understanding of the present disclosure. It would be appreciated that the drawings and embodiments of the present disclosure are only for the purpose of illustration and are not intended to limit the scope of protection of the present disclosure.

In the description of the embodiments of the present disclosure, the term “including” and similar terms would be appreciated as open inclusion, that is, “including but not limited to”. The term “based on” would be appreciated as “at least partially based on”. The term “one embodiment” or “the embodiment” would be appreciated as “at least one embodiment”. The term “some example embodiments” would be appreciated as “at least some example embodiments”. Other explicit and implicit definitions may also be included below. As used herein, the term “model” can represent the matching degree between various data. For example, the above matching degree can be obtained based on various technical solutions currently available and/or to be developed in the future.

It will be appreciated that the data involved in this technical proposal (including but not limited to the data itself, data acquisition or use) shall comply with the requirements of corresponding laws, regulations and relevant provisions.

It will be appreciated that before using the technical solution disclosed in each embodiment of the present disclosure, users should be informed of the type, the scope of use, the use scenario, etc. of the personal information involved in the present disclosure in an appropriate manner in accordance with relevant laws and regulations, and the user's authorization should be obtained.

For example, in response to receiving an active request from a user, a prompt message is sent to the user to explicitly prompt the user that the operation requested operation by the user will need to obtain and use the user's personal information. Thus, users may select whether to provide personal information to the software or the hardware such as an electronic device, an application, a server or a storage medium that perform the operation of the technical solution of the present disclosure according to the prompt information.

As an optional but non-restrictive implementation, in response to receiving the user's active request, the method of sending prompt information to the user may be, for example, a pop-up window in which prompt information may be presented in text. In addition, pop-up windows may also contain selection controls for users to choose “agree” or “disagree” to provide personal information to electronic devices.

It will be appreciated that the above notification and acquisition of user authorization process are only schematic and do not limit the implementations of the present disclosure. Other methods that meet relevant laws and regulations may also be applied to the implementation of the present disclosure.

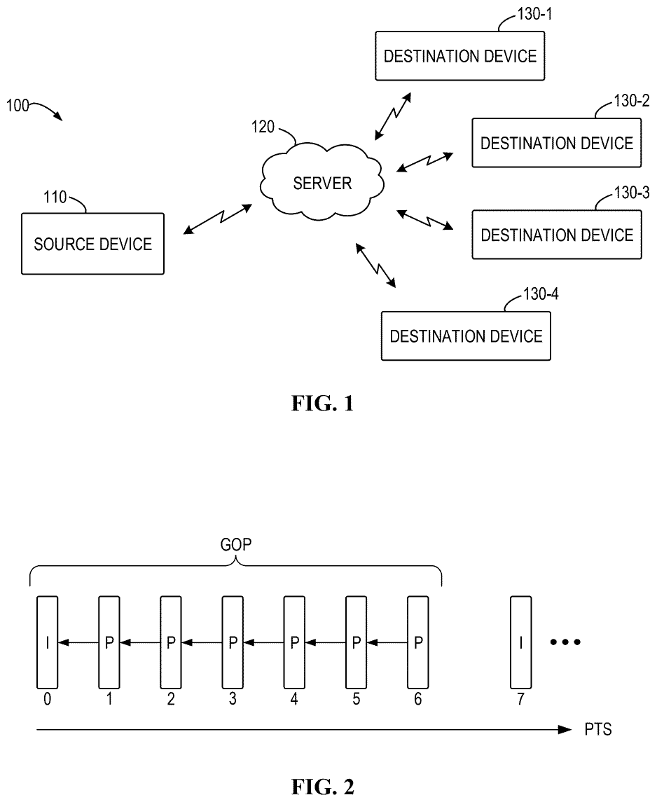

FIG. 1 illustrates a schematic diagram of an example environment 100 in which embodiments of the present disclosure can be implemented. As shown in FIG. 1, the example environment 100 generally involves a source device 110, a server 120, and destination devices 130-1, 130-2, 130-3 and 130-4. For the sake of description below, the destination devices 130-1, 130-2, 130-3 and 130-4 may also be referred to as a destination device 130 collectively or separately. It should be understood that the number of the destination devices 130 shown in FIG. 1 is merely illustrative, and the example environment 100 may comprise less destination devices or more destination devices.

For example, the source device 110 may include a video source, a video encoder, and an input/output (I/O) interface. The video source may include a source such as a video capture device. Examples of the video capture device include, but are not limited to, a camera, an interface to receive video data from a video content provider, a computer graphics system for generating video data, and/or a combination thereof.

The video may comprise one or more pictures, i.e., one or more frames. The video encoder encodes the video from the video source to generate a bitstream, i.e., encoded data of the video. The bitstream may include a sequence of bits that form a coded representation of the video. The bitstream may include coded pictures and associated data. The coded picture is a coded representation of a picture. The associated data may include sequence parameter sets, picture parameter sets, and other syntax structures. The I/O interface may include a modulator/demodulator and/or a transmitter. In the example shown in FIG. 1, the bitstream of the video may be transmitted via the I/O interface to the server 120 at first, and the server 120 transmits the bitstream to a destination device.

The destination device 130 may include an I/O interface, a video decoder, and a display device. The I/O interface may include a receiver and/or a modem. The I/O interface may receive encoded video data from the source device 110 or the server 120. The video decoder may decode the encoded video data, and the display device may display the decoded video data to a user. The display device may be integrated with the destination device, or may be external to the destination device 130 which is configured to interface with an external display device.

The video encoder and the video decoder may operate according to a video compression standard, such as the High Efficiency Video Coding (HEVC) standard, Versatile Video Coding (VVC) standard and other current and/or further standards.

It should be understood that the structure and function of each element in the environment 100 is described for illustrative purposes only and does not imply any limitations on the scope of the present disclosure. By way of example, the bitstream of the video may also be transmitted directly to a destination device, rather than through the server 120.

As briefly mentioned above, RTC is a near-simultaneous exchange of information over any type of telecommunications service from a sender to a receiver in a connection with smaller end-to-end latency. However, the end-to-end latency in RTC is affected by various factors and thus it is generally expected to reduce the end-to-end latency adaptively. According to an existing design, a sender may determine whether to drop a part of frames of a video based on a condition of a network between the sender and a receiver. However, the network condition is only one of the various factors that may affect the end-to-end latency in RTC, and thus the end-to-end latency in RTC may be further improved.

According to another existing design, an IPPPPPP structure is employed for a group of pictures (GOP) for video coding. FIG. 2 illustrates a schematic diagram of the IPPPPPP structure. As shown in FIG. 2, the initial frame (i.e., frame 0) in the GOP is an intra frame (I-frame), i.e., a frame that is code using intra prediction only. Each of the remining frames (i.e., frames 1, 2, 3, 4, 5, and 6) in the GOP is a predictive frame (P-frame), i.e., a frame that is coded using intra prediction or using inter prediction with at most one motion vector and reference index to predict the sample values of the frame. Arrows in FIG. 2 illustrate the reference relationship of these frames. For example, a frame 1 refers to a frame 0, that is, the frame 0 is used as a reference frame for coding the frame 1. Similarly, a frame 2 refers to the frame 1, a frame 3 refers to the frame 2, a frame 4 refers to the frame 3, a frame 5 refers to the frame 4, and a frame 6 refers to the frame 5. In this structure, the presentation time stamp (PTS) of each frame is the same as its decoding time stamp (DTS). However, this structure leads to a lower compression ration of the video, data volume to be transmitted is increased and thus the end-to-end latency increases.

According to embodiments of the present disclosure, an improved solution for video data communication is proposed. According to a solution according to embodiments of the present disclosure, a first apparatus obtains encoded data of a video comprising a set of frames. Each of the set of frames is assigned to one of a plurality of levels based on a reference relationship of the set of frames. The first apparatus further receives, from a second apparatus, feedback information associated with at least one performance attribute representing performance information for processing the encoded data of the video at the second apparatus. Moreover, the first apparatus selects at least one target frame from the set of frames based on the feedback information and the plurality of levels, and transmits encoded data of the at least one target frame to the second apparatus. Correspondingly, the second apparatus transmits, to the first apparatus, feedback information associated with at least one performance attribute representing performance information for processing encoded data of a video at the second apparatus. In addition, the second apparatus receives, from the first apparatus, encoded data of the at least one target frame of the video. The at least one target frame is dependent on the feedback information.

Based on the solution according to embodiments of the present disclosure, frames of a video are grouped to a plurality of levels based on a reference relationship of the frames. The second apparatus provides feedback information associated with at least one performance attribute at the second apparatus to the first apparatus. Based on the plurality of levels and the feedback information, the first apparatus selects at least one target frame to be transmitted to the second apparatus. That is, the frame dropping decision is made by considering the plurality of levels of the video frames and the feedback information regarding performance information for processing the encoded data of the video at the second apparatus. Thereby, the end-to-end latency can be further reduced adaptively, and thus the quality of RTC can be further improved.

Example embodiments of the present disclosure will be described in detail below with reference to the accompanying drawings.

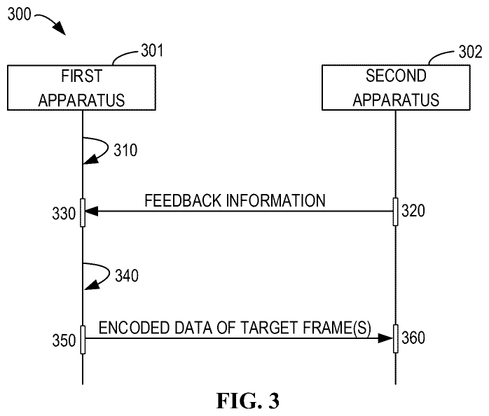

FIG. 3 illustrates a signaling chart 300 for video data communication according to some example embodiments of the present disclosure. The signaling chart 300 involves a first apparatus 301 and a second apparatus 302. In some example embodiments, the first apparatus 301 may be configured to implement the source device 110 shown in FIG. 1, and the second apparatus 302 may be configured to implement the server 120 shown in FIG. 1. In some alternative example embodiments, the first apparatus 301 may be configured to implement the server 120 shown in FIG. 1, and the second apparatus 302 may be configured to implement the destination device 130 shown in FIG. 1. In some further example embodiments, the first apparatus 301 may be configured to implement a source device 110, and the second apparatus 302 may be configured to implement a destination device 130 which is directly communicatively coupled with the source device 110.

In the signaling chart 300, the first apparatus 301 obtains 310 encoded data of a video. In some example embodiments, the encoded data may be generated by the first apparatus 301 (e.g., the source device 110) through a video encoder. Alternatively, the first apparatus 301 (e.g., the server 120) may be communicatively coupled with a further apparatus (e.g., the source device 110), and the encoded data of the video may be received from the further apparatus. For example, the video may comprise video data for real-time communication (RTC). It should be noted that, in addition to RTC, the solution according to some example embodiments of the present disclosure may also be applied to any other suitable scenarios for video data communication.

In addition, the video comprises a set of frames, and each of the set of frames is assigned to one of a plurality of levels based on a reference relationship of the set of frames. In some example embodiments, one of the set of frames of the video may be assigned to one of the plurality of levels based on whether this frame is an I-frame, a P-frame or a bi-predictive frame (B-frame). As used herein, a B-frame is a frame that is decoded using intra prediction or using inter prediction with at most two motion vectors and reference indices to predict the sample values of the frame.

By way of example, a first frame of the video may be assigned to a first level among the plurality of levels if the first frame is an I-frame. The first frame may be assigned to a second level among the plurality of levels if the first frame is a P-frame for which an I-frame or a P-frame is used as a reference frame. The first frame may be assigned to a third level among the plurality of levels if the first frame is a B-frame without being referenced by a further frame of the video. In this case, each frame belonging to the third level is not referenced by a frame belonging to the first or second level, and each frame belonging to the second level is not referenced by a frame belonging to the first level.

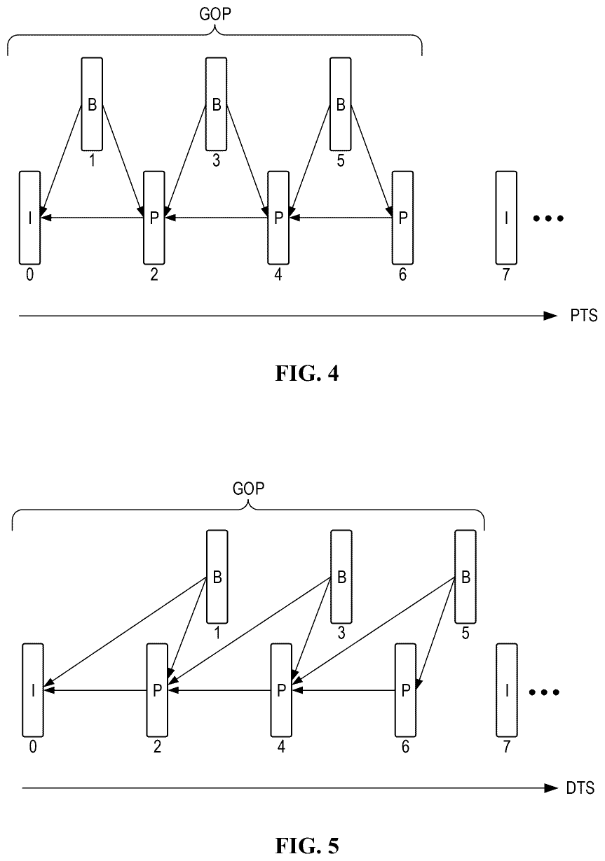

For purpose of illustration, an IBPBPBP structure will be taken as an example. FIG. 4 illustrates a schematic diagram of an IBPBPBP structure in a PTS order. It should be understood that although the solution according to some example embodiments of the present disclosure will be described with reference to the IBPBPBP structure shown in FIG. 4, the proposed solution may also be applied to any other suitable GOP structure, such as an IBBPBBP structure or the like. The scope of the present disclosure is not limited in this respect.

As shown in FIG. 4, the GOP comprises 7 frames, wherein a frame 0 is an I-frame, frames 2, 4, and 6 are P-frames, and frames 1, 3 and 5 are B-frames. Arrows in FIG. 4 illustrates the reference relationship of these frames. For example, the frame 2 refers to the frame 0, and the frame 1 refers to both frames 0 and 2. In this case, although the frame 1 precedes the frame 2 in the PTS order, the frame 1 shall be coded after the frame 2 is coded. In other words, the frame 1 follows the frame 2 in the DTS order. Similarly, the frame 3 follows the frame 4 in the DTS order, and the frame 5 follows the frame 6 in the DTS order. FIG. 5 illustrates a schematic diagram of the IBPBPBP structure in the DTS order.

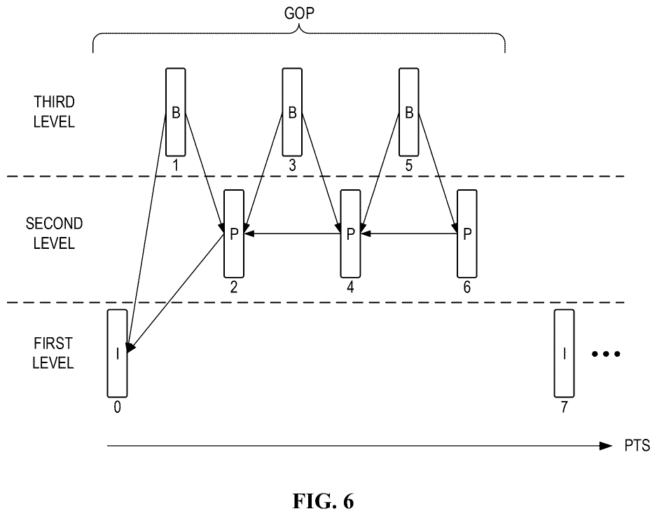

In the example shown in FIGS. 4 and 5, since the frame 0 is an I-frame, the frame 0 may be assigned to a first level. Similarly, the frame 7 may also be assigned to the first level. Since the frame 1 is a B-frame without being referenced by a further frame, the frame 1 may be assigned to a third level. Similarly, the frames 3 and 5 may also be assigned to the third level. In addition, since the frame 2 is a P-frame for which an I-frame is used as a reference frame, the frame 2 may be assigned to a second level. Since the frame 4 is a P-frame for which a P-frame is used as a reference frame, the frame 4 may be assigned to the second level. Similarly, the frame 6 may also be assigned to the second level. FIG. 6 illustrates a schematic diagram of the hierarchical structure of the IBPBPBP structure. It should be noted that each of the above mentioned first, second and third levels may also be referred to as a temporal layer.

With reference to FIG. 6, it is apparent that each frame belonging to the third level is not referenced by a frame belonging to the first or second level, and each frame belonging to the second level is not referenced by a frame belonging to the first level. That is, each frame belonging to the first or second level can be coded independently from frames belonging to the third level, and each frame belonging to the first level can be coded independently from frames belonging to the second level. In this case, a part of or all of the frames belonging to the third level may be dropped (i.e., not transmitted) without affecting the correct decoding to frames belonging to the first or second level. Furthermore, a part of or all of the frames belonging to the second level may be dropped without affecting the correct decoding to frames belonging to the first level.

In some example embodiments, the result of the above-described assignment can be signaled in the related data packets (packets for short hereinafter). For example, at least one packet carrying encoded data of a frame may comprise a first indication indicating one of the plurality of levels to which the frame belongs to. By way of example rather than limitation, the first indication may be a syntax element named as Temporal ID, TID or the like. With reference to FIG. 6, a value of the first indication in one or more packets carrying encoded data of the frame 0 may be equal to 0, which indicates that the frame 0 belongs to the first level. The value of the first indication in one or more packets carrying encoded data of the frame 1 may be equal to 2, which indicates that the frame 1 belongs to the third level. The value of the first indication in one or more packets carrying encoded data of the frame 2 may be equal to 1, which indicates that the frame 2 belongs to the second level. It should be understood that the specific values recited herein are intended to be exemplary rather than limiting the scope of the present disclosure.

Additionally or alternatively, the at least one packet may comprise a second indication indicating whether a group of pictures (GOP) of the video comprises a B-frame. By way of example rather than limitation, the second indication may be a syntax element named as B frame gop, BG or the like. In addition, or alternatively, the at least one packet may comprise a third indication indicating a prediction type of the frame. By way of example rather than limitation, the third indication may be syntax element named as slice_type or the like.

In aid of the above-described indication(s), the hierarchical structure of a GOP can be determined by parsing the received packets. Thereby, the hierarchical structure of a GOP can be signaled more efficiently, and thus the speed of processing the packets can be improved. It should be understood that the possible implementations of the indications described above are merely illustrative and therefore should not be construed as limiting the present disclosure in any way.

Turning back to FIG. 3, the second apparatus 302 transmits 320, to the first apparatus 301, feedback information associated with at least one performance attribute representing performance information for processing the encoded data of the video at the second apparatus. The at least one performance attribute may be different from a condition of a network connection between the first apparatus 301 and the second apparatus 302. In some example embodiments, the at least one performance attribute may comprise at least one of the following: (i) a hardware performance metric regarding a capability of the second apparatus 302 for processing the encoded data of the video, or (ii) a latency metric regarding displaying the video at the second apparatus 302. For example, the feedback information may be transmitted periodically. Alternatively, the feedback information may be transmitted after the second apparatus 302 receives a request for the feedback information. The scope of the present disclosure is not limited in this respect. Correspondingly, the first apparatus 301 receives 330 the feedback information from the second apparatus 302.

For example, the hardware performance metric may comprise central processing unit (CPU) usage and/or a CPU temperature. For example, if the CPU usage is high and the CPU temperature is also high, the decoding speed the second apparatus 302 is slow, in some cases the second apparatus 302 may even crash. As such, the user experience deteriorates. In this case, it is desired to reduce the frame rate of encoded data to be transmitted to the second apparatus 302, and thus frame dropping may be enabled due to the hardware performance metric.

Moreover, the latency metric may comprise an end-to-end latency. The end-to-end latency may indicate a time difference between a time point when the video is captured and a time point when the video is displayed at the second apparatus 302. For example, if the end-to-end latency is high, the real-time performance degrades at the second apparatus 302, which is detrimental to the user experience. In this case, it is also desired to reduce the frame rate of encoded data to be transmitted to the second apparatus 302, and thus frame dropping may be enabled due to the latency metric.

In some example embodiments, the frame dropping decision may be made at the first apparatus 301. In this case, the feedback information may indicate the at least one performance attribute itself, e.g., the hardware performance metric, the latency metric, and/or the like. After receiving the hardware performance metric and/or the latency metric, the first apparatus 301 may make the frame dropping decision based on the hardware performance metric and/or the latency metric. This will be described in detail below. In aid of making the frame dropping decision at the first apparatus 301, the computing resource at the second apparatus 302 can be saved. Thereby, the second apparatus 302 can provide better performance to the user, and thus user experience can be improved.

Alternatively, the above-mentioned frame dropping decision may be made at the second apparatus 302, and the feedback information may indicate whether to enable frame dropping due to the at least one performance attribute. For example, the feedback information may indicate at least one of: whether to enable frame dropping due to the hardware performance metric, or whether to enable frame dropping due to the latency metric. For example, in response to the hardware performance metric is worse than a performance threshold, the second apparatus 302 may determine that frame dropping is enable due to the hardware performance metric. Furthermore, the second apparatus 302 may transmit 320 this determination as the feedback information to the first apparatus 301. Similarly, in response to the latency metric being larger than a latency threshold, the second apparatus 302 may determine that frame dropping is enable due to the latency metric, and this determination may be transmitted 320 as the feedback information to the first apparatus 301. In this case, only the result of frame dropping decision needs to be transmitted, which may be transmitted simply, e.g., by using a flag, an index or the like. Thereby, the data volume to be transmitted is reduced and the network resource can be saved.

It should be understood that the possible implementations of the at least one performance attribute, the hardware performance metric and the latency metric described above are merely illustrative and therefore should not be construed as limiting the present disclosure in any way. By way of example rather than limitation, the hardware performance metric may also comprise a computing speed of the second apparatus 302. Furthermore, in addition to the at least one performance attribute, the feedback information may also comprise any other suitable information regarding factors that may affect the end-to-end latency of RTC, such as network bandwidth, round-trip time, network latency, packet loss rate, and/or the like.

After receiving 330 the feedback information, the first apparatus 301 may select 340 at least one target frame from the set of frames of the video based on the feedback information and the plurality of levels. For example, the first apparatus 301 may determine, based on the feedback information, whether to enable frame dropping for transmitting the encoded data of the video.

As mentioned above, in a case where the frame dropping decision is made at the second apparatus 302, the feedback information may indicate at least one of: whether to enable frame dropping due to the hardware performance metric, or whether to enable frame dropping due to the latency metric. In this case, if frame dropping is enabled due to the hardware performance metric or the latency metric, the first apparatus 301 may determine that frame dropping is enable for transmitting the encoded data of the video. If frame dropping is not enabled due to the hardware performance metric and the latency metric, the first apparatus 301 may determine that frame dropping is not enable for transmitting the encoded data of the video.

As briefly described above, in a case where the frame dropping decision is made at the first apparatus 301, the feedback information may indicate the hardware performance metric itself and/or the latency metric itself. In this case, the first apparatus 301 may compare the hardware performance metric and the latency metric with a performance threshold and the latency threshold, respectively. If the hardware performance metric is worse than the performance threshold or the latency metric is larger than the latency threshold, the first apparatus 301 may determine that frame dropping is enable for transmitting the encoded data of the video. If the hardware performance metric is better than a performance threshold and the latency metric is smaller than a latency threshold, the first apparatus 301 may determine that frame dropping is not enable for transmitting the encoded data of the video.

Furthermore, if it is determined that frame dropping is not enable for transmitting the encoded data of the video, the first apparatus 301 may determine all of the set of frames as the at least one target frame. In other words, all frames of the video will be transmitted to the second apparatus 302 without dropping any frame. If it is determined that frame dropping is enable for transmitting the encoded data of the video, the first apparatus 301 may further determine the at least one target frame from the set of frames based on the plurality of levels.

For example, the first apparatus 301 may determine, as the at least one target frame, at least one frame of the set of frames that belongs to a first set of levels among the plurality of levels, and drop at least one frame of the set of frames that belongs to a second set of levels among the plurality of levels. Each frame belonging to the second set of levels is not referenced by a frame belonging to the first set of levels. With reference to FIG. 6, the first apparatus 301 may determine frames at the first level and the second level (comprising I-frames and P-frames in this example) as the at least one target frame to be transmitted to the second apparatus 302. That is, frames at the third level (comprising B-frames in this example) will be dropped and thus not transmitted to the second apparatus 302. Based on the above discussion with reference to FIGS. 4-6, the dropping of the frames at the third level will not affect the correct decoding of the frames at the first and second levels. Thereby, the frame rate of encoded data transmitted to the second apparatus 302 can be reduced while the correct decoding of the frames is still ensured.

It should be noted that the above-described frame dropping strategy is merely an example, any other suitable frame dropping strategy may also be employed. By way of example, instead of dropping all frames at the third level, the first apparatus 301 may determine to drop only a part of the frames at the third level, e.g., based on the feedback information. Additionally or alternatively, some or all of the frames at the second level may also be dropped. The scope of the present disclosure is not limited in this respect.

Turing back to FIG. 3, the first apparatus 301 transmits 350 encoded data of the selected at least one target frame to the second apparatus 302, and the second apparatus 302 receives 360 the encoded data of the at least one target frame. It should be understood that although the actions involved in the signaling chart 300 are described in a particular order, in some other example embodiments these actions may be performed in a different order.

In view of the forgoing, the first apparatus may selectively drop frames of the video based on hierarchical levels of the GOP of the video, and the feedback information associated with the at least one performance attribute at the second apparatus. Thereby, the frame rate and thus the bitrate of encoded data transmitted to the second apparatus can be reduced adaptively while the correct decoding of the frames is still ensured. As such, the end-to-end latency of the RTC can be further reduced while maintaining the video playback smoothness and thus the user experience can be improved.

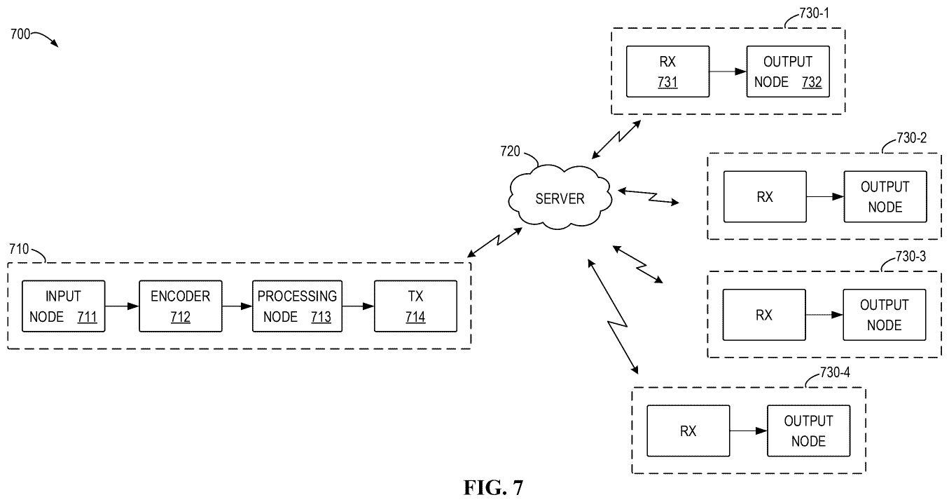

The solutions presented above will be described in more details below with reference to FIG. 7, which illustrates a schematic diagram of an architecture 700 for video data communication according to some example embodiments of the present disclosure. As shown in FIG. 7, the architecture 700 generally involves a source device 710, a server 720, and destination devices 730-1, 730-2, 730-3 and 730-4. The source device 710 may be an example implementation of the source device 710 110 in FIG. 1, the server 720 may be an example implementation of the server 120 in FIG. 1, and the destination devices 730-1, 730-2, 730-3 and 730-4 may be an example implementation of the destination device 130 in FIG. 1.

The source device 710 comprises an input node 711, an encoder 712, a processing node 713 and a transmitter (TX) 714. The input node 711 may provide captured video data to encoder 712. The encoder 712 encodes the video data into bitstream, i.e., encoded data. In some example embodiments, in response to an indication for enabling encoding with B-frame, e.g., from a configuration node (not shown), the encoder 712 may encode the video data by using a GOP with B-frame. For example, the IBPBPBP structure shown in FIG. 4 may be employed.

Based on the bitstream, the processing node 713 may determine whether to and how to organize the encoded data with a hierarchical structure. By way of example, the processing node 713 may determine the reference relationship of the video frames by parsing the bitstream. If it is determined that all P-frames do not use a B-frame as a reference frame, the processing node 713 may decide to organize the encoded data with a hierarchical structure. An example hierarchical structure of GOP is shown in FIG. 6. Based on the hierarchical structure of GOP, the processing node 713 may encapsulate the encoded data into packets, and add one or more indications indicating the hierarchical structure (such as the above-described syntax elements Temporal ID, B frame gop, slice_type, and/or the like) to the packets.

Furthermore, the transmitter 714 may transmit the encoded data to the server 720. In some example embodiments, the server 720 may provide feedback information regarding the network condition, hardware performance metric, end-to-end latency metric and/or the like to the transmitter 714. Based on the feedback information, the transmitter 714 may determine whether to enable frame dropping. By way of example, if it is detected that the network bandwidth decreases, the transmitter 714 may drop B-frames, and only transmits encoded data of I-frames and P-frames. Thereby, the network congestion can be mitigated and thus the encoded data can be transmitted more efficiently.

After receiving the encoded data from the transmitter 714, the server 720 may transmit the encoded data to the destination devices 730-1, 730-2, 730-3 and 730-4, e.g., in response to a request for video data. Each of the destination devices 730-1, 730-2, 730-3 and 730-4 may provide feedback information regarding the network condition, hardware performance metric, end-to-end latency metric and/or the like to the server 720. Based on the feedback information, the server 720 may also determine whether to enable frame dropping for a corresponding destination device. Each of the destination devices 730-1, 730-2, 730-3 and 730-4 may comprise a receiver (RX) and an output node. Taking the destination device 730-1 as an example, the receiver 731 received encoded video data and the encoded video data may be decoded by a video decoder (not shown). The output node 732 may render the reconstructed frames of the video and display them to a user.

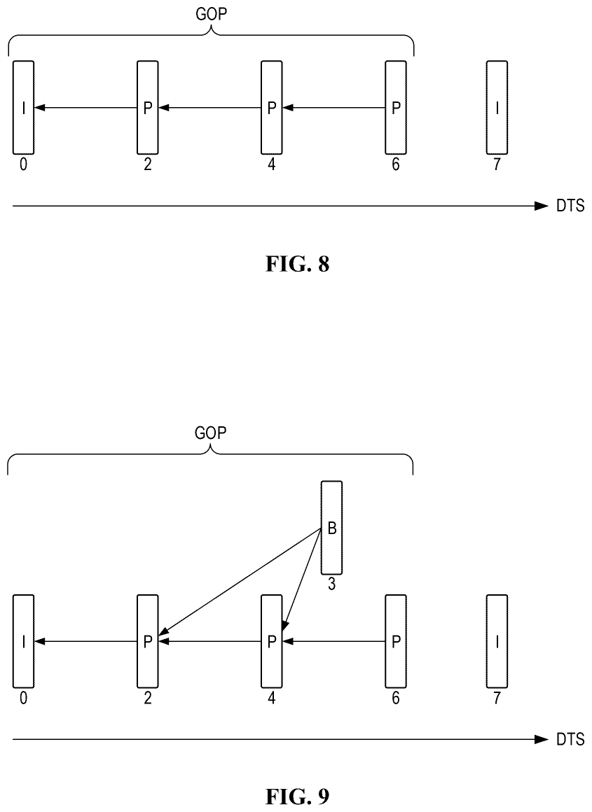

For purpose of illustration, it is assumed that at the source device 710, the resolution of the video data is 360P, the frame rate is 20 frames per second (fps), and the bitrate is 800 kilobit per second (kbps). The encoded video data is transmitted from the source device 710 to the server 720 without frame dropping, and thus at the server 720, the above three parameters are unchanged. Four different example scenarios will be described to illustrate the solution according to embodiments of the present disclosure.
Scenario 1: the network connection between the destination device 730-1 and the server 720 and the hardware performance metric of the destination device 730-1 both are in a good state, and the latency metric at the destination device 730-1 is also relatively low. In this case, the server 720 will transmit the received encoded vide data without frame dropping. Therefore, at the destination device 730-1, the resolution is 360P, the frame rate is 20 fps, and the bitrate is 800 kbps.
Scenario 2: the CPU usage and CPU temperature are relatively high, and thus the hardware performance metric of the destination device 730-2 is poor. In this case, the destination device 730-2 is not capable of decoding the original encoded video data, which may lead to crash and video stuttering. The destination device 730-2 may provide such information to the server 720 as feedback information. Based on the feedback information, the server 720 may reduce the frame rate by dropping frames, e.g., dropping all frames belonging to the third level, and transmit encoded data of frames belonging to the first and second level to the destination device 730-2. FIG. 8 illustrates a schematic diagram of a GOP structure after frame dropping for this scenario. Compared with FIG. 4, frames 1, 3, and 5, which are B-frames, are dropped. In this case, at the destination device 730-2, the resolution is 360P, the frame rate is reduced to nearly 10 fps, and the bitrate is also reduced to lower than 800 kbps. Since none of the remaining frames (i.e., frames 0, 2, 4, 6, 7) uses the dropped frames as reference frame, the destination device 730-2 can still decode the remaining frames properly. Thereby, the encoded video data received at the destination device 730-2 is adapted to its performance, and thus the video can be displayed to the user properly with a small end-to-end latency and a smooth video playback.
Scenario 3: the bandwidth of the network connection between the destination device 730-3 and the server 720 deteriorates, which may lead to network congestion and video stuttering. For example, the destination device 730-3 may provide the network bandwidth as feedback information to the server 720. Alternatively, the server 720 may detect the network bandwidth by itself. Based on the inadequate bandwidth, the server 720 may drop a part of video frames. For example, the number of the video frames to be dropped may be determined based on the network bandwidth, so as to better fit the network condition. FIG. 9 illustrates a schematic diagram of a GOP structure after frame dropping for this scenario. Compared with FIG. 4, frames 1 and 5, which are B-frames, are dropped. In this case, at the destination device 730-3, the resolution is 360P, the frame rate is reduced to nearly 12 fps, and the bitrate is also reduced to lower than 800 kbps. Since none of the remaining frames (i.e., frames 0, 2, 3, 4, 6, 7) uses the dropped frames as reference frame, the destination device 730-3 can still decode the remaining frames properly. Thereby, the encoded video data received at the destination device 730-3 is adapted to the network condition, and thus the video can be displayed to the user properly with a small end-to-end latency and a smooth video playback.
Scenario 4: the end-to-end latency at the destination device 730-4 is relatively large, and thus cannot satisfy the requirement of RTC. The destination device 730-4 may provide such information to the server 720 as feedback information. Based on the feedback information, the server 720 may reduce the frame rate by dropping frames, e.g., dropping all frames belonging to the third level, and transmit encoded data of frames belonging to the first and second level to the destination device 730-4, which is same as the example shown in FIG. 8. In this case, at the destination device 730-4, the resolution is 360P, the frame rate is reduced to nearly 10 fps, and the bitrate is also reduced to lower than 800 kbps. Thereby, the encoded video data received at the destination device 730-4 is adapted to the end-to-end latency, and thus the video can be displayed to the user properly with a small end-to-end latency and a smooth video playback.

In some example embodiments, the video data may be live-streaming content. Therefore, the above-described process is performed repeatedly during the entire live-streaming process.

In view of the foregoing, the frame dropping decision is made by considering the hierarchical levels of the video frames and the feedback information regarding network condition, hardware performance metric and/or the latency metric. Thereby, the end-to-end latency can be further reduced adaptively, the unexpected video stuttering can be avoided and thus the quality of RTC can be further improved.

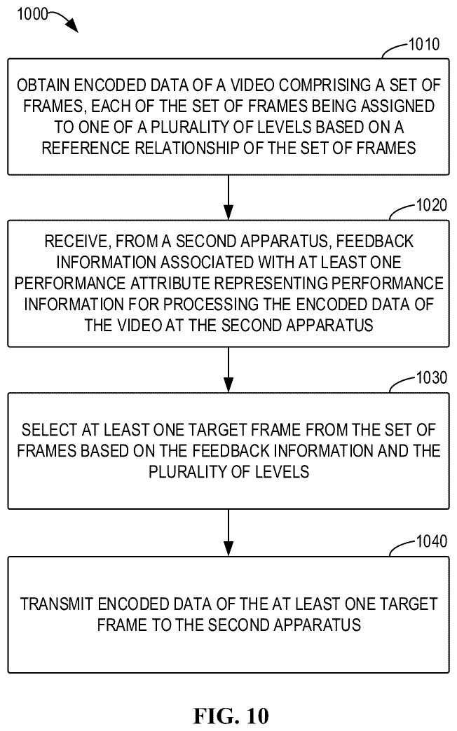

FIG. 10 illustrates a flowchart of a method 1000 for video data communication according to some example embodiments of the present disclosure. For example, the method 1000 may be performed by the source device 110 and/or the server 120 as shown in FIG. 1, and the first apparatus 301 in FIG. 3. It should be understood that the method 1000 may also include additional blocks not shown, and/or blocks shown may be omitted. The scope of the present disclosure is not limited in this respect. For ease of description, the method 1000 is described below with reference to FIG. 3.

At block 1010, the first apparatus 301 obtains encoded data of a video comprising a set of frames. Each of the set of frames is assigned to one of a plurality of levels based on a reference relationship of the set of frames.

At block 1020, the first apparatus 301 receives, from a second apparatus, feedback information associated with at least one performance attribute representing performance information for processing the encoded data of the video at the second apparatus.

At block 1030, the first apparatus 301 selects at least one target frame from the set of frames based on the feedback information and the plurality of levels.

At block 1040, the first apparatus 301 transmits encoded data of the at least one target frame to the second apparatus.

In some example embodiments, the at least one performance attribute comprises at least one of the following: a hardware performance metric regarding a capability of the second apparatus for processing the encoded data, or a latency metric regarding displaying the video at the second apparatus.

In some example embodiments, the hardware performance metric comprises at least one of the following: central processing unit (CPU) usage, or a CPU temperature.

In some example embodiments, the latency metric comprises an end-to-end latency indicating a time difference between a time point when the video is captured and a time point when the video is displayed at the second apparatus.

In some example embodiments, selecting the at least one target frame from the set of frames comprises: determining, based on the feedback information, whether to enable frame dropping for transmitting the encoded data of the video; and in accordance with a determination that frame dropping is not enable for transmitting the encoded data of the video, determining all of the set of frames as the at least one target frame, or in accordance with a determination that frame dropping is enable for transmitting the encoded data of the video, determining the at least one target frame from the set of frames based on the plurality of levels.

In some example embodiments, determining the at least one target frame from the set of frames based on the plurality of levels comprises: determining, as the at least one target frame, at least one frame of the set of frames that belongs to a first set of levels among the plurality of levels; and dropping at least one frame of the set of frames that belongs to a second set of levels among the plurality of levels, wherein each frame belonging to the second set of levels is not referenced by a frame belonging to the first set of levels.

In some example embodiments, the feedback information indicates at least one of: whether to enable frame dropping due to the hardware performance metric, or whether to enable frame dropping due to the latency metric, and determining whether to enable frame dropping for transmitting the encoded data of the video comprises: in response to frame dropping being enabled due to the hardware performance metric or the latency metric, determining that frame dropping is enable for transmitting the encoded data of the video.

In some example embodiments, the feedback information indicates the hardware performance metric, and determining whether to enable frame dropping for transmitting the encoded data of the video comprises: in response to the hardware performance metric being worse than a performance threshold, determining that frame dropping is enable for transmitting the encoded data of the video, or the feedback information indicates the latency metric, and determining whether to enable frame dropping for transmitting the encoded data of the video comprises: in response to the latency metric being larger than a latency threshold, determining that frame dropping is enable for transmitting the encoded data of the video.

In some example embodiments, a first frame of the video is assigned to a first level among the plurality of levels in response to the first frame being an intra frame (I-frame), or the first frame is assigned to a second level among the plurality of levels in response to the first frame being a predictive frame (P-frame) for which an I-frame or a P-frame is used as a reference frame, or the first frame is assigned to a third level among the plurality of levels in response to the first frame being a bi-predictive frame (B-frame) without being referenced by a further frame of the video, wherein each frame belonging to the third level is not referenced by a frame belonging to the first or second level, and each frame belonging to the second level is not referenced by a frame belonging to the first level.

In some example embodiments, at least one packet carrying encoded data of one of the set of frames comprises at least one of the following: an indication indicating one of the plurality of levels to which the frame belongs to, an indication indicating whether a group of pictures (GOP) of the video comprises a B-frame, or an indication indicating a prediction type of the frame.

In some example embodiments, the video comprises video data for real-time communication (RTC).

In some example embodiments, the first apparatus comprises a source device or a server, and the second apparatus comprises a destination device.

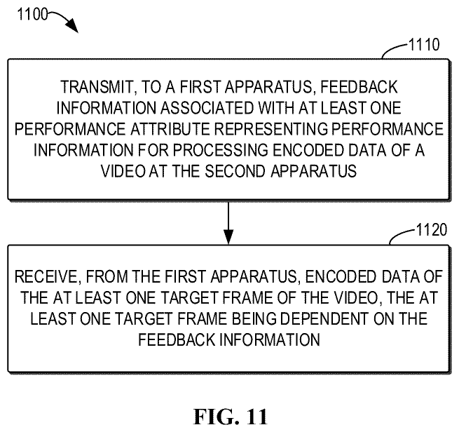

FIG. 11 illustrates a flowchart of a method 1100 for video data communication according to some example embodiments of the present disclosure. For example, the method 1100 may be performed by the server 120 and/or the destination device 130 as shown in FIG. 1, and the second apparatus 302 in FIG. 3. It should be understood that the method 1100 may also include additional blocks not shown, and/or blocks shown may be omitted. The scope of the present disclosure is not limited in this respect. For ease of description, the method 1100 is described below with reference to FIG. 3.

At block 1110, the second apparatus 302 transmits, to a first apparatus, feedback information associated with at least one performance attribute representing performance information for processing encoded data of a video at the second apparatus.

At block 1120, the second apparatus 302 receives, from the first apparatus, encoded data of the at least one target frame of the video. The at least one target frame is dependent on the feedback information.

In some example embodiments, the at least one performance attribute comprises at least one of the following: a hardware performance metric regarding a capability of the second apparatus for processing the encoded data, or a latency metric regarding displaying the video at the second apparatus.

In some example embodiments, the hardware performance metric comprises at least one of the following: central processing unit (CPU) usage, or a CPU temperature.

In some example embodiments, the latency metric comprises an end-to-end latency indicating a time difference between a time point when the video is captured and a time point when the video is displayed at the second apparatus.

In some example embodiments, the feedback information indicates at least one of: whether to enable frame dropping due to the hardware performance metric, or whether to enable frame dropping due to the latency metric, and the method further comprises: in response to the hardware performance metric being worse than a performance threshold, determining that frame dropping is enable due to the hardware performance metric, or in response to the latency metric being larger than a latency threshold, determining that frame dropping is enable due to the latency metric.

In some example embodiments, the feedback information indicates at least one of the hardware performance metric or the latency metric.

In some example embodiments, a first frame of the video is assigned to a first level in response to the first frame being an I-frame, or the first frame is assigned to a second level in response to the first frame being a P-frame for which an I-frame or a P-frame is used as a reference frame, or the first frame is assigned to a third level in response to the first frame being a B-frame without being referenced by a further frame of the video, wherein each frame belonging to the third level is not referenced by a frame belonging to the first or second level, and each frame belonging to the second level is not referenced by a frame belonging to the first level.

In some example embodiments, at least one packet carrying encoded data of one of the at least one target frame comprises at least one of the following: an indication indicating one of the plurality of levels to which the frame belongs to, an indication indicating whether a group of pictures (GOP) of the video comprises a B-frame, or an indication indicating a prediction type of the frame.

In some example embodiments, the video comprises video data for real-time communication (RTC).

In some example embodiments, the first apparatus comprises a source device or a server, and the second apparatus comprises a destination device.

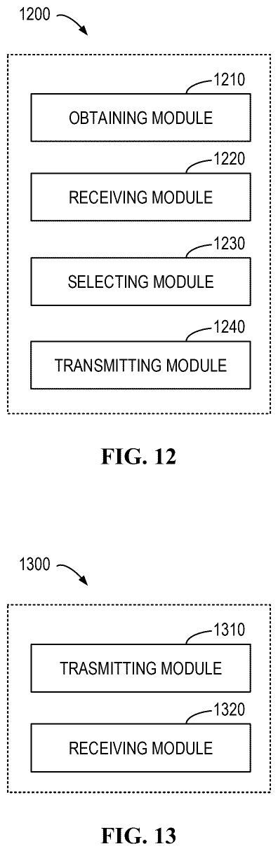

FIG. 12 illustrates a block diagram of a first apparatus 1200 for video data communication according to some example embodiments of the present disclosure. The first apparatus 1200 may be implemented, for example, or included at the source device 110 and/or the server 120 as shown in FIG. 1, and the first apparatus 301 in FIG. 3. Various modules/components in the first apparatus 1200 may be implemented by hardware, software, firmware, or any combination thereof.

As shown in FIG. 12, the first apparatus 1200 includes an obtaining module 1210, a receiving module 1220, a selecting module 1230, and a transmitting module 1240. The obtaining module 1210 is configured to obtain encoded data of a video comprising a set of frames. Each of the set of frames is assigned to one of a plurality of levels based on a reference relationship of the set of frames. The receiving module 1220 is configured to receive, from a second apparatus, feedback information associated with at least one performance attribute representing performance information for processing the encoded data of the video at the second apparatus. The selecting module 1230 is configured to select at least one target frame from the set of frames based on the feedback information and the plurality of levels. The transmitting module 1240 is configured to transmit encoded data of the at least one target frame to the second apparatus.

In some example embodiments, the at least one performance attribute comprises at least one of the following: a hardware performance metric regarding a capability of the second apparatus for processing the encoded data, or a latency metric regarding displaying the video at the second apparatus.

In some example embodiments, the hardware performance metric comprises at least one of the following: central processing unit (CPU) usage, or a CPU temperature.

In some example embodiments, the latency metric comprises an end-to-end latency indicating a time difference between a time point when the video is captured and a time point when the video is displayed at the second apparatus.

In some example embodiments, the selecting module 1230 is further configure for: determining, based on the feedback information, whether to enable frame dropping for transmitting the encoded data of the video; and in accordance with a determination that frame dropping is not enable for transmitting the encoded data of the video, determining all of the set of frames as the at least one target frame, or in accordance with a determination that frame dropping is enable for transmitting the encoded data of the video, determining the at least one target frame from the set of frames based on the plurality of levels.

In some example embodiments, determining the at least one target frame from the set of frames based on the plurality of levels comprises: determining, as the at least one target frame, at least one frame of the set of frames that belongs to a first set of levels among the plurality of levels; and dropping at least one frame of the set of frames that belongs to a second set of levels among the plurality of levels, wherein each frame belonging to the second set of levels is not referenced by a frame belonging to the first set of levels.

In some example embodiments, the feedback information indicates at least one of: whether to enable frame dropping due to the hardware performance metric, or whether to enable frame dropping due to the latency metric, and determining whether to enable frame dropping for transmitting the encoded data of the video comprises: in response to frame dropping being enabled due to the hardware performance metric or the latency metric, determining that frame dropping is enable for transmitting the encoded data of the video.

In some example embodiments, the feedback information indicates the hardware performance metric, and determining whether to enable frame dropping for transmitting the encoded data of the video comprises: in response to the hardware performance metric being worse than a performance threshold, determining that frame dropping is enable for transmitting the encoded data of the video, or the feedback information indicates the latency metric, and determining whether to enable frame dropping for transmitting the encoded data of the video comprises: in response to the latency metric being larger than a latency threshold, determining that frame dropping is enable for transmitting the encoded data of the video.

In some example embodiments, a first frame of the video is assigned to a first level among the plurality of levels in response to the first frame being an intra frame (I-frame), or the first frame is assigned to a second level among the plurality of levels in response to the first frame being a predictive frame (P-frame) for which an I-frame or a P-frame is used as a reference frame, or the first frame is assigned to a third level among the plurality of levels in response to the first frame being a bi-predictive frame (B-frame) without being referenced by a further frame of the video, wherein each frame belonging to the third level is not referenced by a frame belonging to the first or second level, and each frame belonging to the second level is not referenced by a frame belonging to the first level.

In some example embodiments, at least one packet carrying encoded data of one of the set of frames comprises at least one of the following: an indication indicating one of the plurality of levels to which the frame belongs to, an indication indicating whether a group of pictures (GOP) of the video comprises a B-frame, or an indication indicating a prediction type of the frame.

In some example embodiments, the video comprises video data for real-time communication (RTC).

In some example embodiments, the first apparatus comprises a source device or a server, and the second apparatus comprises a destination device.

FIG. 13 illustrates a block diagram of a second apparatus 1300 for video data communication according to some example embodiments of the present disclosure. The second apparatus 1300 may be implemented, for example, or included at the server 120 and/or the destination device 130 as shown in FIG. 1, and the second apparatus 302 in FIG. 3. Various modules/components in the second apparatus 1300 may be implemented by hardware, software, firmware, or any combination thereof.

As shown in FIG. 13, the second apparatus 1300 comprises a transmitting module 1310 and a receiving module 1320. The transmitting module 1310 is configured to transmit, at a second apparatus and to a first apparatus, feedback information associated with at least one performance attribute representing performance information for processing encoded data of a video at the second apparatus. The receiving module 1320 is configured to receive, from the first apparatus, encoded data of the at least one target frame of the video, the at least one target frame being dependent on the feedback information.

In some example embodiments, the at least one performance attribute comprises at least one of the following: a hardware performance metric regarding a capability of the second apparatus for processing the encoded data, or a latency metric regarding displaying the video at the second apparatus.

In some example embodiments, the hardware performance metric comprises at least one of the following: central processing unit (CPU) usage, or a CPU temperature.

In some example embodiments, the latency metric comprises an end-to-end latency indicating a time difference between a time point when the video is captured and a time point when the video is displayed at the second apparatus.

In some example embodiments, the feedback information indicates at least one of: whether to enable frame dropping due to the hardware performance metric, or whether to enable frame dropping due to the latency metric. The second apparatus 1300 further comprises a determining module configure for: in response to the hardware performance metric being worse than a performance threshold, determining that frame dropping is enable due to the hardware performance metric, in response to the latency metric being larger than a latency threshold, determining that frame dropping is enable due to the latency metric.

In some example embodiments, the feedback information indicates at least one of the hardware performance metric or the latency metric.

In some example embodiments, a first frame of the video is assigned to a first level in response to the first frame being an I-frame, or the first frame is assigned to a second level in response to the first frame being a P-frame for which an I-frame or a P-frame is used as a reference frame, or the first frame is assigned to a third level in response to the first frame being a B-frame without being referenced by a further frame of the video, wherein each frame belonging to the third level is not referenced by a frame belonging to the first or second level, and each frame belonging to the second level is not referenced by a frame belonging to the first level.

In some example embodiments, at least one packet carrying encoded data of one of the at least one target frame comprises at least one of the following: an indication indicating one of the plurality of levels to which the frame belongs to, an indication indicating whether a group of pictures (GOP) of the video comprises a B-frame, or an indication indicating a prediction type of the frame.

In some example embodiments, the video comprises video data for real-time communication (RTC).

In some example embodiments, the first apparatus comprises a source device or a server, and the second apparatus comprises a destination device.

The units and/or modules included in the first apparatus 1200 and the second apparatus 1300 may be implemented in various forms, including software, hardware, firmware, or any combination thereof. In some example embodiments, one or more units and/or modules may be implemented using software and/or firmware, such as machine-executable instructions stored on a storage medium. In addition to or as an alternative to machine-executable instructions, some or all of the units and/or modules in the first apparatus 1200 and the second apparatus 1300 may be implemented, at least in part, by one or more hardware logic components. By way of example and not limitation, example types of hardware logic components that may be used include field programmable gate arrays (FPGAs), application specific integrated circuits (ASICs), application specific standards (ASSPs), system-on-a-chip (SOCs), complex programmable logic devices (CPLDs), and the like.

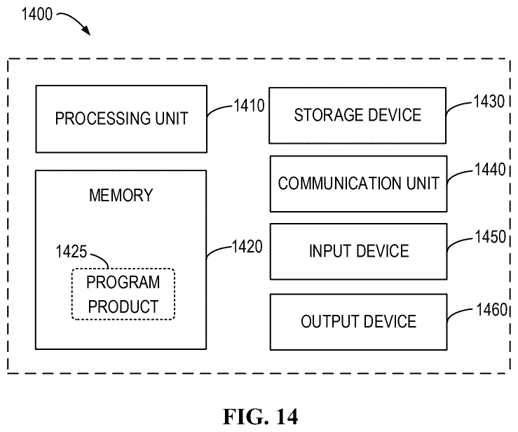

FIG. 14 illustrates a block diagram of an electronic device 1400 in which one or more embodiments of the present disclosure can be implemented. It would be appreciated that the electronic device 1400 shown in FIG. 14 is only an example and should not constitute any restriction on the function and scope of the embodiments described herein. The electronic device 1400 may be used, for example, to implement the source device 110, the server 120 and/or the destination device 130 of FIG. 1. The electronic device 1400 may also be used to implement the first apparatus 301 and/or the second apparatus 302 of FIG. 3.

As shown in FIG. 14, the electronic device 1400 is in the form of a general computing device. The components of the electronic device 1400 may include, but are not limited to, one or more processors or processing units 1410, a memory 1420, a storage device 1430, one or more communication units 1440, one or more input devices 1450, and one or more output devices 1460. The processing unit 1410 may be an actual or virtual processor and can execute various processes according to the programs stored in the memory 1420. In a multiprocessor system, multiple processing units execute computer executable instructions in parallel to improve the parallel processing capability of the electronic device 1400.

The electronic device 1400 typically includes a variety of computer storage medium. Such medium may be any available medium that is accessible to the electronic device 1400, including but not limited to volatile and non-volatile medium, removable and non-removable medium. The memory 1420 may be volatile memory (for example, a register, cache, a random access memory (RAM)), a non-volatile memory (for example, a read-only memory (ROM), an electrically erasable programmable read-only memory (EEPROM), a flash memory) or any combination thereof. The storage device 1430 may be any removable or non-removable medium, and may include a machine-readable medium, such as a flash drive, a disk, or any other medium, which can be used to store information and/or data (such as training data for training) and can be accessed within the electronic device 1400.

The electronic device 1400 may further include additional removable/non-removable, volatile/non-volatile storage medium. Although not shown in FIG. 14, a disk driver for reading from or writing to a removable, non-volatile disk (such as a “floppy disk”), and an optical disk driver for reading from or writing to a removable, non-volatile optical disk can be provided. In these cases, each driver may be connected to the bus (not shown) by one or more data medium interfaces. The memory 1420 may include a computer program product 1425, which has one or more program modules configured to perform various methods or acts of various embodiments of the present disclosure.

The communication unit 1440 communicates with a further computing device through the communication medium. In addition, functions of components in the electronic device 1400 may be implemented by a single computing cluster or multiple computing machines, which can communicate through a communication connection. Therefore, the electronic device 1400 may be operated in a networking environment using a logical connection with one or more other servers, a network personal computer (PC), or another network node.

The input device 1450 may be one or more input devices, such as a mouse, a keyboard, a trackball, etc. The output device 1460 may be one or more output devices, such as a display, a speaker, a printer, etc. The electronic device 1400 may also communicate with one or more external devices (not shown) through the communication unit 1440 as required. The external device, such as a storage device, a display device, etc., communicate with one or more devices that enable users to interact with the electronic device 1400, or communicate with any device (for example, a network card, a modem, etc.) that makes the electronic device 1400 communicate with one or more other computing devices. Such communication may be executed via an input/output (I/O) interface (not shown).

According to example implementation of the present disclosure, a computer-readable storage medium is provided, on which a computer-executable instruction or computer program is stored, where the computer-executable instructions or the computer program is executed by the processor to implement the method described above. According to example implementation of the present disclosure, a computer program product is also provided. The computer program product is physically stored on a non-transient computer-readable medium and includes computer-executable instructions, which are executed by the processor to implement the method described above.

Various aspects of the present disclosure are described herein with reference to the flow chart and/or the block diagram of the method, the device, the equipment and the computer program product implemented in accordance with the present disclosure. It would be appreciated that each block of the flowchart and/or the block diagram and the combination of each block in the flowchart and/or the block diagram may be implemented by computer-readable program instructions.

These computer-readable program instructions may be provided to the processing units of general-purpose computers, special computers or other programmable data processing devices to produce a machine that generates a device to implement the functions/acts specified in one or more blocks in the flow chart and/or the block diagram when these instructions are executed through the processing units of the computer or other programmable data processing devices. These computer-readable program instructions may also be stored in a computer-readable storage medium. These instructions enable a computer, a programmable data processing device and/or other devices to work in a specific way. Therefore, the computer-readable medium containing the instructions includes a product, which includes instructions to implement various aspects of the functions/acts specified in one or more blocks in the flowchart and/or the block diagram.

The computer-readable program instructions may be loaded onto a computer, other programmable data processing apparatus, or other devices, so that a series of operational steps can be performed on a computer, other programmable data processing apparatus, or other devices, to generate a computer-implemented process, such that the instructions which execute on a computer, other programmable data processing apparatus, or other devices implement the functions/acts specified in one or more blocks in the flowchart and/or the block diagram.

The flowchart and the block diagram in the drawings show the possible architecture, functions and operations of the system, the method and the computer program product implemented in accordance with the present disclosure. In this regard, each block in the flowchart or the block diagram may represent a part of a module, a program segment or instructions, which contains one or more executable instructions for implementing the specified logic function. In some alternative implementations, the functions marked in the block may also occur in a different order from those marked in the drawings. For example, two consecutive blocks may actually be executed in parallel, and sometimes can also be executed in a reverse order, depending on the function involved. It should also be noted that each block in the block diagram and/or the flowchart, and combinations of blocks in the block diagram and/or the flowchart, may be implemented by a dedicated hardware-based system that performs the specified functions or acts, or by the combination of dedicated hardware and computer instructions.

Each implementation of the present disclosure has been described above. The above description is example, not exhaustive, and is not limited to the disclosed implementations. Without departing from the scope and spirit of the described implementations, many modifications and changes are obvious to ordinary skill in the art. The selection of terms used in this article aims to best explain the principles, practical application or improvement of technology in the market of each implementation, or to enable other ordinary skill in the art to understand the various embodiments disclosed herein.

I/We claim:

1. A method for video data communication, comprising:
obtaining, at a first apparatus, encoded data of a video comprising a set of frames, each of the set of frames being assigned to one of a plurality of levels based on a reference relationship of the set of frames;
receiving, from a second apparatus, feedback information associated with at least one performance attribute representing performance information for processing the encoded data of the video at the second apparatus;
selecting at least one target frame from the set of frames based on the feedback information and the plurality of levels; and
transmitting encoded data of the at least one target frame to the second apparatus.

2. The method of claim 1, wherein the at least one performance attribute comprises at least one of the following:
a hardware performance metric regarding a capability of the second apparatus for processing the encoded data, or
a latency metric regarding displaying the video at the second apparatus.

3. The method of claim 2, wherein the hardware performance metric comprises at least one of the following:
central processing unit (CPU) usage, or a CPU temperature, or
wherein the latency metric comprises an end-to-end latency indicating a time difference between a time point when the video is captured and a time point when the video is displayed at the second apparatus.

4. The method of claim 2, wherein selecting the at least one target frame from the set of frames comprises:
determining, based on the feedback information, whether to enable frame dropping for transmitting the encoded data of the video; and
in accordance with a determination that frame dropping is not enable for transmitting the encoded data of the video, determining all of the set of frames as the at least one target frame, or
in accordance with a determination that frame dropping is enable for transmitting the encoded data of the video, determining the at least one target frame from the set of frames based on the plurality of levels.

5. The method of claim 4, wherein determining the at least one target frame from the set of frames based on the plurality of levels comprises:
determining, as the at least one target frame, at least one frame of the set of frames that belongs to a first set of levels among the plurality of levels; and
dropping at least one frame of the set of frames that belongs to a second set of levels among the plurality of levels,
wherein each frame belonging to the second set of levels is not referenced by a frame belonging to the first set of levels.

6. The method of claim 4, wherein the feedback information indicates at least one of: whether to enable frame dropping due to the hardware performance metric, or whether to enable frame dropping due to the latency metric, and determining whether to enable frame dropping for transmitting the encoded data of the video comprises:
in response to frame dropping being enabled due to the hardware performance metric or the latency metric, determining that frame dropping is enable for transmitting the encoded data of the video.

7. The method of claim 4, wherein the feedback information indicates the hardware performance metric, and determining whether to enable frame dropping for transmitting the encoded data of the video comprises: in response to the hardware performance metric being worse than a performance threshold, determining that frame dropping is enable for transmitting the encoded data of the video, or
the feedback information indicates the latency metric, and determining whether to enable frame dropping for transmitting the encoded data of the video comprises: in response to the latency metric being larger than a latency threshold, determining that frame dropping is enable for transmitting the encoded data of the video.

8. The method of claim 1, wherein,
a first frame of the video is assigned to a first level among the plurality of levels in response to the first frame being an intra frame (I-frame), or
the first frame is assigned to a second level among the plurality of levels in response to the first frame being a predictive frame (P-frame) for which an I-frame or a P-frame is used as a reference frame, or
the first frame is assigned to a third level among the plurality of levels in response to the first frame being a bi-predictive frame (B-frame) without being referenced by a further frame of the video,
wherein each frame belonging to the third level is not referenced by a frame belonging to the first or second level, and each frame belonging to the second level is not referenced by a frame belonging to the first level.

9. The method of claim 1, wherein at least one packet carrying encoded data of one of the set of frames comprises at least one of the following:
an indication indicating one of the plurality of levels to which the frame belongs to,
an indication indicating whether a group of pictures (GOP) of the video comprises a B-frame, or
an indication indicating a prediction type of the frame.

10. The method of claim 1, wherein the video comprises video data for real-time communication (RTC).

11. The method of claim 1, wherein the first apparatus comprises a source device or a server, and the second apparatus comprises a destination device.

12. A method for video data communication, comprising:
transmitting, at a second apparatus and to a first apparatus, feedback information associated with at least one performance attribute representing performance information for processing encoded data of a video at the second apparatus; and
receiving, from the first apparatus, encoded data of at least one target frame of the video, the at least one target frame being dependent on the feedback information.

13. The method of claim 12, wherein the at least one performance attribute comprises at least one of the following:
a hardware performance metric regarding a capability of the second apparatus for processing the encoded data, or
a latency metric regarding displaying the video at the second apparatus.

14. The method of claim 13, wherein the hardware performance metric comprises at least one of the following: central processing unit (CPU) usage, or a CPU temperature, or
wherein the latency metric comprises an end-to-end latency indicating a time difference between a time point when the video is captured and a time point when the video is displayed at the second apparatus.

15. The method of claim 13, wherein the feedback information indicates at least one of: whether to enable frame dropping due to the hardware performance metric, or whether to enable frame dropping due to the latency metric, and the method further comprises:
in response to the hardware performance metric being worse than a performance threshold, determining that frame dropping is enable due to the hardware performance metric, or
in response to the latency metric being larger than a latency threshold, determining that frame dropping is enable due to the latency metric.

16. The method of claim 13, wherein the feedback information indicates at least one of the hardware performance metric or the latency metric.

17. The method of claim 12, wherein,
a first frame of the video is assigned to a first level in response to the first frame being an I-frame, or
the first frame is assigned to a second level in response to the first frame being a P-frame for which an I-frame or a P-frame is used as a reference frame, or
the first frame is assigned to a third level in response to the first frame being a B-frame without being referenced by a further frame of the video,
wherein each frame belonging to the third level is not referenced by a frame belonging to the first or second level, and each frame belonging to the second level is not referenced by a frame belonging to the first level.

18. The method of claim 12, wherein at least one packet carrying encoded data of one of the at least one target frame comprises at least one of the following:
an indication indicating one of a plurality of levels to which the frame belongs,
an indication indicating whether a group of pictures (GOP) of the video comprises a B-frame, or
an indication indicating a prediction type of the frame.

19. The method of claim 12, wherein the video comprises video data for real-time communication (RTC), or
wherein the first apparatus comprises a source device or a server, and the second apparatus comprises a destination device.

20. An electronic device, comprising:
at least one processing unit; and
at least one memory coupled to the at least one processing unit and storing instructions for execution by the at least one processing unit that, when executed by the at least one processing unit, cause the electronic device to perform acts comprising:
obtaining encoded data of a video comprising a set of frames, each of the set of frames being assigned to one of a plurality of levels based on a reference relationship of the set of frames;
receiving, from a second apparatus, feedback information associated with at least one performance attribute representing performance information for processing the encoded data of the video at the second apparatus;
selecting at least one target frame from the set of frames based on the feedback information and the plurality of levels; and
transmitting encoded data of the at least one target frame to the second apparatus.
